(19) United States
(12) Patent Application Publication
(10) Pub. No.: US 2017/0230302 A1
(43) Pub. Date: Aug. 10, 2017

(54) REQUEST AUTHENTICATION AND CONFIRMATION

(71) Applicant: Zeta (Better World Technology Pvt. Ltd.), Mumbai Maharastra (IN)

(72) Inventors: Bhavin Turakhia, Mumbai Maharastra (IN); Ramakrishna Gaddipatti, Mumbai Maharastra (IN)

(21) Appl. No.: 15/083,564

(22) Filed: Mar. 29, 2016

(30) Foreign Application Priority Data
Feb. 9, 2016 (IN) 201621004632

(51) Int. Cl. H04L 12/911; H04L 29/06; H04W 4/02

(52) U.S. Cl. CPC H04L 47/70; H04W 4/021; H04L 63/102

(57) ABSTRACT

In example embodiments, a system and method performs authentication and confirmation of requests within a control server system. Accordingly, a first message is received from a first device, the control server system responds to the request by providing a first code to the first device and the control server system maps the first code to a first identifier of the first user. The control server system receives a second request, including the first code, from a second device. The control server system selects the first identifier based on inclusion of the first code in the second request and requests a confirmation of the second request from the first device. The control server system processes the second request based on receipt of the confirmation from the first device.

### CLAIM FOR PRIORITY

This application claims the benefit of priority to Indian Patent Application No. 201621004632, filed on 9 Feb. 2016, entitled “REQUEST AUTHENTICATION AND CONFIRMATION” which is incorporated herein by reference in its entirety.

### FIELD

The present disclosure relates generally to electronic communications, and in a specific example embodiment, to request authentication and confirmation with a system.

### BACKGROUND

Typically, when two entities engage in a transaction, such as transmitting communications between the two entities, a first entity transmits a message to a second entity. The second entity receives the transmitted message without further interaction by the first entity. The transmission of the message indicates completion of the communication. Affirmation of the communication by the first user is assumed based on the initiation of the communication by the first entity.

### BRIEF DESCRIPTION OF DRAWINGS

Various ones of the appended drawings merely illustrate example embodiments of the present inventive concepts and cannot be considered as limiting its scope.

FIG. 1 is a diagram illustrating a system for request authentication and confirmation, according to some example embodiments.

FIG. 2 is a block diagram illustrating a client device, according to some example embodiments.

FIG. 3 is a block diagram illustrating a control server system, according to some example embodiments.

FIG. 4 is a flow diagram of a method for request authentication and confirmation, according to some example embodiments.

FIG. 5 is a flow diagram of a method for request authentication and confirmation, according to some example embodiments.

FIG. 6 is a flow diagram of a method for request authentication and confirmation, according to some example embodiments.

FIG. 7 is a flow diagram of a method for request authentication and confirmation, according to some example embodiments.

FIG. 8 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present inventive subject matter. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

Example embodiments described herein provide systems and methods for request authentication and confirmation to reconcile first requests, generated codes, and second requests. The first requests and the second requests may be provided using two distinct devices. Authentication and confirmation may be performed to reconcile first requests, or codes provided based on the first requests, with a second requests. A control server system receives a request triggered by an application operating on a user device. The control server system responds to the first request with a code provided for use in authenticating a subsequent request.

In one example embodiment, systems and methods herein describe an interaction between two users in which the control server system authenticates and confirms requests between two client devices to authorize and cause transfer of a value between the users. In these example embodiments, the first user instructs the control server to provide a code using a first request. The control server system provides the code to the first device. The control server system then receives a second request from a second device. The second request includes the code. In some instances the first user may provide the first code to the second user of the second device. The first user may provide the code by stating the code to the second user or sending the code from the first device to the second device in a message or other transmission. The second request may include a value to be transferred from an account associated with the first user or first device to an account associated with the second user or second device. The second request may act as a portion of a transaction, such as an invoice statement or debit request, between the first user and the second user. Receipt of the second request causes the control server system to authenticate the second request based on inclusion of the first code. The authenticating may involve obtaining a confirmation of the same from the first user. Upon authenticating the second request, the control server system transfers the value from the account of the first user to the account of the second user.

Accordingly, one or more of the methodologies discussed herein may obviate a need for the first user in a value transfer between the first user and the second user to interact directly with devices associated with the second user or the second domain. This may have the technical effect of reducing computing resources used by one or more devices of the first user and the second user. Examples of such computing resources include, without limitation, processor cycles, network traffic, memory usage, storage space, and power consumption. The methodologies described herein enable the first user and the second user to interact with one another and transfer values without specialized equipment or connectivity other than a mobile telephone and a network through which the mobile telephone may communicate. The systems and methods described herein may also have the technical effect of reducing the generation, tracking, and proliferation of security tokens (e.g., identification tokens) associated with the second domain, enabling more effective and secure use of security tokens. Additionally this has the benefit of the second user being able to leverage existing investments of devices in transfer of value using the control server system.

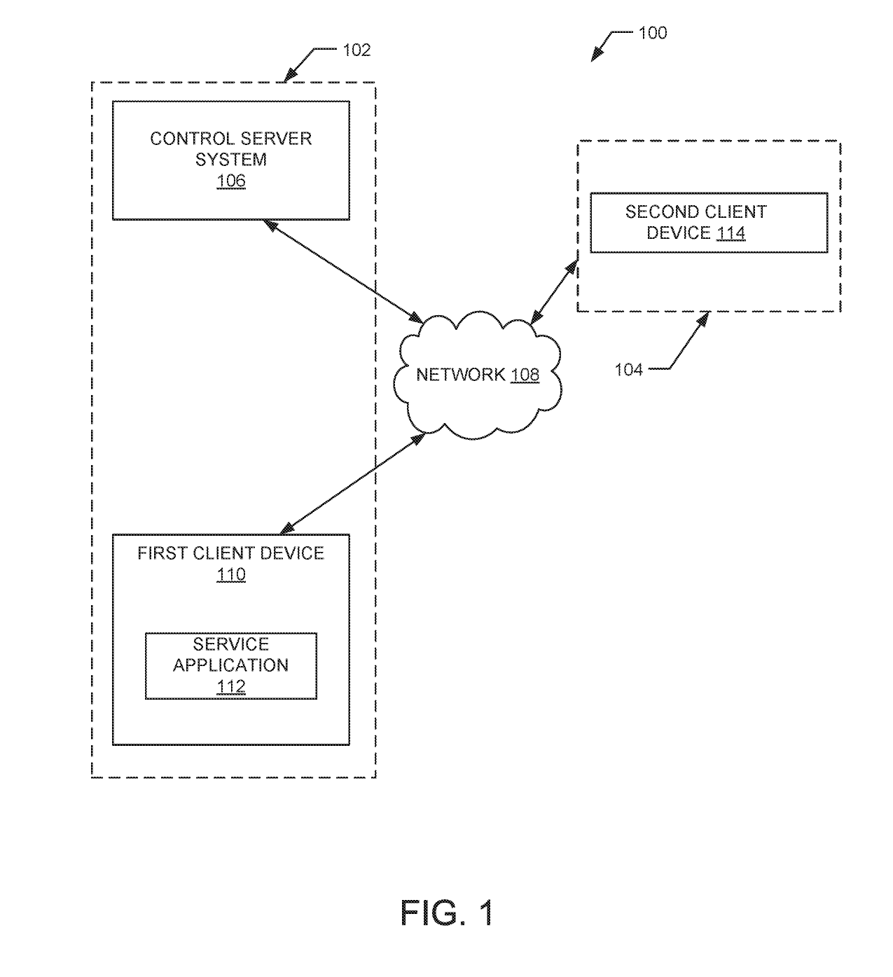

With reference to FIG. 1, a diagram illustrating an example environment 100 in which embodiments of a system for request authentication and confirmation is shown. The environment 100 comprises a first domain 102 and a second domain 104. The first domain 102 contains a control server system 106 coupled via a network 108 (e.g., the Internet, wireless network, cellular network, or a Wide Area Network (WAN)) to a plurality of user devices. As shown in FIG. 1, the plurality of user devices are represented by a first client device 110, shown as a portion of the first domain 102 and including a service application 112. The second domain 104 contains a second client device 114. Although FIG. 1 shows the first domain 102 including the first client device 110 and the second domain 104 containing the second device 114, in some embodiments, the first domain 102 may include the first client device 110 and the second client device 114.

Each client device 110 is associated with a user (e.g., a first user associated with the first client device 110 where the user is a member of or otherwise associated with the first domain 102) that has downloaded or otherwise installed a service application 112 onto their respective client device 110. The client device 110 may comprise a mobile phone, laptop, tablet, or any other communication device that a user may utilize to store, access, or operate the service application 112.

The service application 112 comprises application programming, functionality, or modules on the client device 110 that generates requests and messages enabling the control server system 106 to perform operations verifying, authenticating, reconciling, and processing requests from one or more client devices (e.g., the first client device 110 and the second client device 114). To that end, the control server system 106 may provide the service application 112 to one or more of the first client device 110 (e.g., provide a downloadable version of the service application 112, electronically send the service application 112 to the first client device 110, physically send to the first user via a storage medium such as a CD ROM) and the second client device 114.

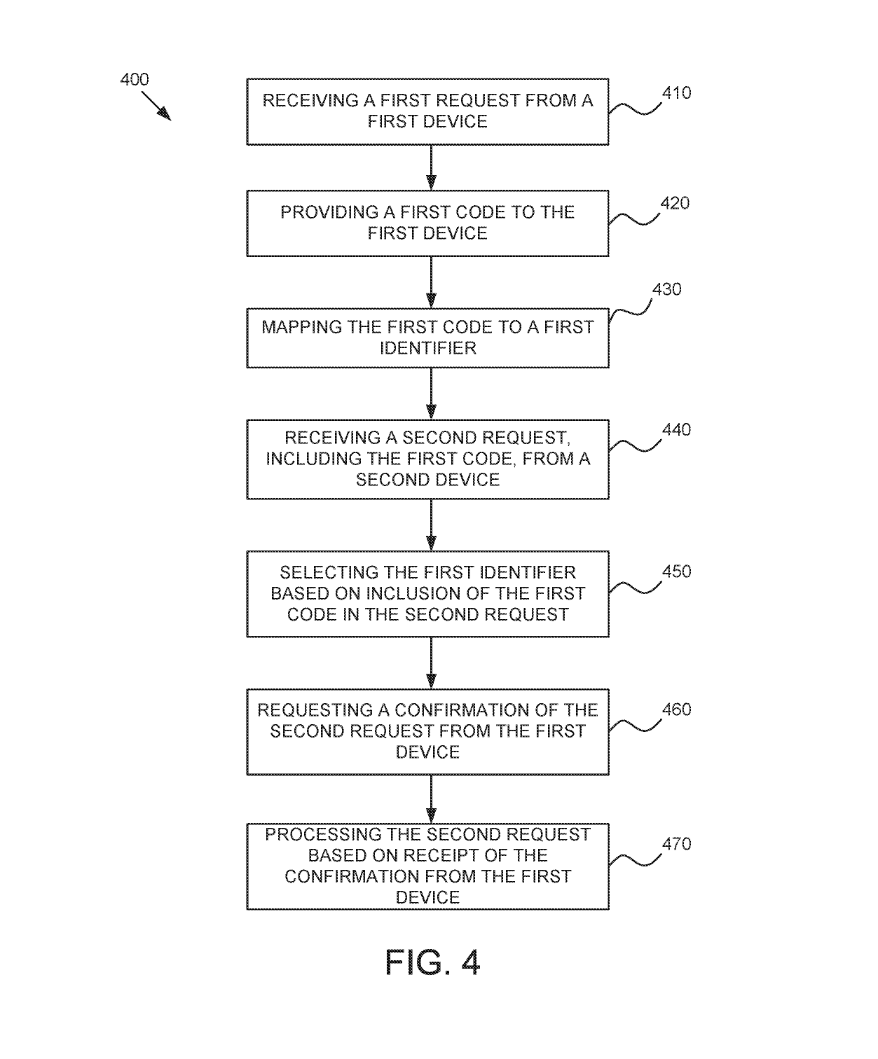

Once the service application 112 is installed on the first client device 110, the service application 112 may automatically verify a user identification corresponding to the first user associated with the first client device 110 (e.g., mobile number, e-mail address, phone number) and authenticate the first client device 110 and/or the user with the control server system 106. The authentication process may occur in the background of the first client device 110 without any user intervention. In example embodiments, the verification of the first user and the first client device 110 may comprise, in part, a registration process to register the first user with the control server and the first domain 102. The authentication process will be discussed in more detail in connection with FIG. 4 below.

The second client device 114 is a device associated with the second domain 104. The second client device 114 may be a client device including a service application similar to the first client device 110 and the service application 112, described above. Where the second client device 114 is associated with the second domain 104, the second client device 114 may be an electronic data capture terminal, a point of sale terminal, or any other suitable device and the second domain may be a payment network (e.g., a credit card network) such that the second client device 114 performs one or more payment operations through the second domain 104. The second client device 114 may be registered or otherwise associated with the control server system 106. In some embodiments, the second client device 114 is a device capable of communication with the control server system 106 using a predefined message format. The second client device 114 may be a credit card reader, a point of sale system, a mobile phone, a tablet, a computer, a laptop, or any other suitable device configured to communicate the second domain 104 or the control server system 106 within the first domain 102. The second client device 114 may generate messages and requests for transmission to the control server system 106. In some embodiments, the second client device 114 may receive confirmation messages from the control server system 106.

It is noted that the environment 100 shown in FIG. 1 is exemplary. Alternative example embodiments may comprise any number of control server systems 106 and client devices in communication in the environment 100.

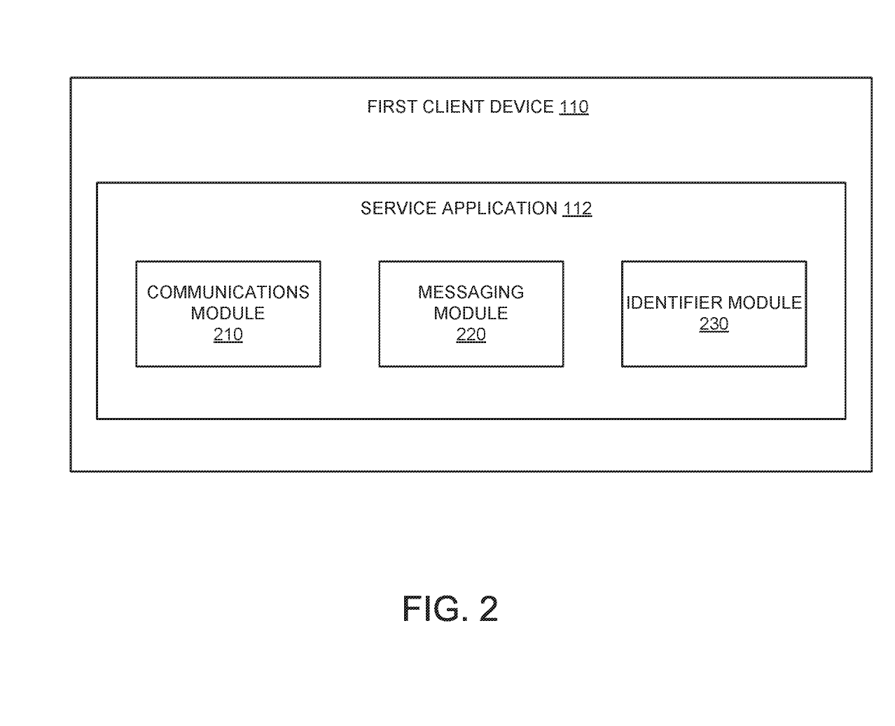

Referring now to FIG. 2, a block diagram illustrating an example embodiment of the first client device 110 is shown. The first client device 110 is shown having the service application 112 installed thereon. The service application 112 provides functionality and services to the first client device 110 that may be provided to and from the control server system 106. To enable the functionality on the first client device 110, the service application 112 may comprise a communications module 210, a messaging module 220, and an identifier module 230. It is noted that the service application 112 may comprise other modules not pertinent to example embodiments that are not shown or discussed.

The communications module 210 manages communications with the control server system 106. Upon installation, the communications module 210 may exchange communications with the control server system 106 to perform the verification and authentication (e.g., registration) of the first user and the first client device 110 with the control server system 106 and the first domain 102. In example embodiments, the communications module 210 may take over control of one or more communication capabilities of the first client device 110. In some instances, the communications module 210 takes control of one or more of the SMS messaging capabilities, the WiFi communication capabilities, and the cellular communication capabilities of the first client device 110 to exchange the communications with the control server system 106. The communications module 210 may determine a communication address for the control server system 106. The communication address may be a service number (e.g., phone number) or an address within the first domain 102. For example the address may be an Internet Protocol (IP) address, a domain name, or a uniform resource identifier (URI) for the control server system 106. The URI may be a uniform resource locator (URL) or a uniform resource name (URN). The communications module 210 uses the communication address to send a registration message to the control server system 106. In example embodiments, the communication address may be fetched by the communications module 210 from the control server system 106. Alternatively, the communication address may be hardcoded into the service application 112. The communications module 210 also receives reply messages from the control server system 106

In various example embodiments, the messaging module 220 generates one or more registration messages and requests for transmission to the control server system 106 by the communications module 210. The one or more registration messages may establish an account of the first user with the control server system 106 and verify the identity of the first user. In example embodiments, the one or more registration messages include one or more of identification, demographic, and location information transmitted to the control server system 106 by the communications module 210. The messaging module 220 may also generate and transmit requests to the control server system 106 for codes generated by the control server system 106 to be used for authentication of messages and requests from other client devices and forming part of a transaction between the first client device 110 and the other client devices.

In various embodiments, the identifier module 230 may apply an identifier associated with the first client device 110 or the first user to messages transmitted by the messaging module 220 to the control server system 106. In some embodiments, the identifier module 230 verifies messages received from the control server system 106 contain the identifier for the first client device 110 or the first user. In some instances, the identifier module 230 automatically verifies an identifier received from the control server system 106 and included in a message transmitted from the second client device 114. The identifier module 230 may be verified based on entrance of the identifier associated with the second client device 114 into a message or request transmitted to the control server system 106 by the first client device 110.

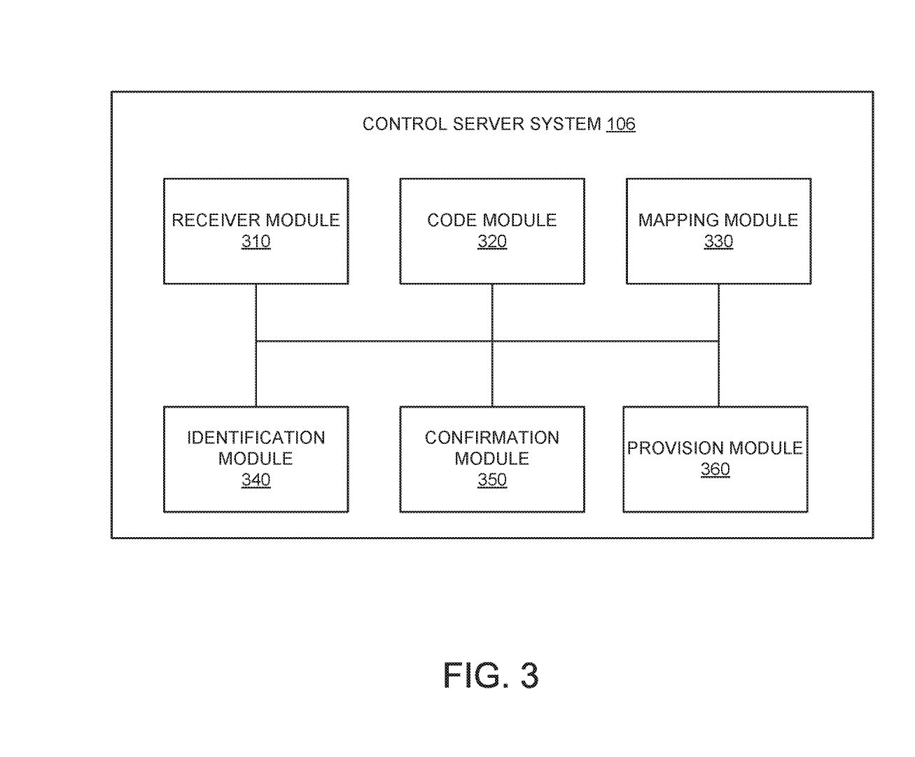

Referring now to FIG. 3, the control server system 106 is shown in more detail. In example embodiments, the control server system 106 comprises one or more servers that provide functionality and services to the service applications 112 running on the first client device 110. Prior to allowing the service application 112 to access content or functionalities with the control server system 106, the contact identifier (e.g., user identification) corresponding to the first client device 110 is verified as belonging to one or more of the first client device 110 and the first user. Validating the user identification authenticates the first client device 110 and the first user as associated with the first domain 102 and the control server system 106. In example embodiments, the control server system 106 uses the user identification (e.g., mobile number) corresponding to the first client device 110 or the first user as an authentication vector. Accordingly, the control server system 106 may comprise a receiver module 310, a code module 320, a mapping module 330, an identification module 340, a confirmation module 350, and a provision module 360. Alternative example embodiments may comprise more, less, or other modules for methods of request authentication and confirmation. Some functions of the modules may be combined or divided into two or more further modules.

The receiver module 310 is configured to receive requests from client devices (e.g., the first client device 110 or the second client device 114). The receiver module 310 may receive the requests via the network 108 (e.g., the Internet) or any other suitable network. The receiver module 310 may pass at least a portion of received requests to one or more additional modules of the control server system 106.

The code module 320 provides codes the client devices in response to the receiver module 310 receiving a specified request. In some embodiments, the code module 320 provides codes by selecting codes from a predetermined set of codes. The code module 320 may also generate codes upon receiving an indication of a request. The code module 320 may pass generated or selected codes to one or more module of the control server system 106.

The mapping module 330 maps codes to identifiers associated with client devices from which requests for codes were received. The mapping module 330 may generate and modify data structures detailing associations between codes and identifiers. In some embodiments, the mapping module 330 includes additional information in the map such as geographical location data, time data, expiration periods for time data, and other suitable identifying or tracking information. The mapping module 330 may monitor generated maps to identify and remove associations between codes and identifiers based on expiration of time data included in the association.

The identification module 340 selects identifiers based on inclusion in requests identified as responding to an initial request, identifier, and code. In some embodiments, the identification module passes identifiers from the map to other modules within the control server system 106. The identification module 340 may also identify locations within requests. Based on identification of two or more locations within two or more requests, the identification module 340 may determine geographical proximities such as distances, radii, or coexistence within a region, city, street, or other geographical area.

The confirmation module 350 generates and transmits confirmation requests to client devices. In some embodiments, the confirmation module 350 may generate the confirmation requests in response to receiving a request ostensibly responding to a request for a code. In some instances, the confirmation module 350 generates requests based on the identification module 340 identifying a mapping or other association between a code and an identifier. The confirmation module 350 may transmit the confirmation request to the device associated with the identifier associated with a code received in the subsequent request.

The provision module 360 processes requests based on receipt of a confirmation responding to the request for confirmation. In some embodiments, the provision module 360 may process requests by transferring values from an account associated with the identifier mapped to the code and a second account. The provision module 360 may communicate with domains (e.g., the second domain 104) outside the first domain 102 associated with the control server system 106 in order to process requests.

FIG. 4 is a flow diagram of an example method 400 for authentication of requests from a second device based on identifier and code mapping with respect to a first device, such as the first client device 110. The operations of the method 400 may be performed by the control server system 106 which may be embodied on one or more servers.

In operation 410, the receiver module 310 receives a first request from a first device. The first request includes a first identifier of first user. In some embodiments, the first request may be a message configured to fetch a code from the control server system 106. The first request may be generated within an application on the first device and configured to be transmitted to the control server system 106 to cause the control server system 106 to perform a set of operations, described in more detail below.

In some embodiments, the first request may include a first value. The first value may represent a set of data, a message, a monetary value, or any other suitable value within the control server system 106, the first domain 102, or the second domain 104. For example, first request may initiate a transaction between a first user associated with the first device and a second user associated with a second device. The value may be a monetary value representing money being transferred between an account associated with the first user and an account associated with the second user. The value may be entered into a user interface causing generation of the first request within the first device.

In operation 420, the code module 320 provides a first code to the first device. The code module 320 provides the first code in response to the first request being received by the receiver module 310. The code may comprise a set of characters including numbers, letters, non-letter symbols, combinations thereof, or any other suitable characters. In some embodiments, the first code is a six character (e.g., digit) code. In some embodiments, the first code may be generated upon receipt of the first request. Where the code is generated based on the receipt of the first message, the code may be generated based on a portion of the first message, identification information of the first device, identification information of the first user of the first device, based on a random number (e.g., character) algorithm, or any other suitable basis.

In embodiments where the first request includes the value, the first code may be generated based on the value. In some embodiments, the first code may be the value, a modification of the value, a code resulting from performing a mathematical operation on the value, a hash value based on the value, or any other code generated based on the value.

The first code may also be selected upon receipt of the first request. Where the first code is selected, the code module 320 may access a code database. The code database may include a set of preexisting or predetermined codes. The code module 320 may select the first code from the set of predetermined codes based on one or more criteria associated with the first message, the first device, the first user of the first device, a current state of network traffic, combinations thereof, or any other suitable basis.

In some instances, where the first code is selected from a set of predetermined codes in response to the first request, the code module 320 may determine a subset of codes included within the set of predetermined codes for provision to devices in response to a request. The subset of codes may include a predetermined number of unique codes of the set of predetermined codes. In some embodiments, the predetermined number is determined based on the current state of network traffic (e.g., a number of devices requesting codes), a chance of collision (e.g., a probability that a code may be randomly selected and improperly submitted by a third party), and a number of codes of the subset which are currently associated with a client device (e.g., have been provided to a client device in response to a request and not yet released based on a subsequent request). In some embodiments, the code module 320 determines one or more available codes from the subset of codes. The code module 320 may determine the one or more available codes as one or more codes of the subset of codes which are not currently mapped or otherwise associated with a client device in response to a request. The code module 320 may then select the first code from the one or more available codes.

The code module 320 may modify the predetermined set of codes based on one or more provision factors. The one or more provision factors may include a rate at which the control server system 106 is receiving requests for codes, a number of codes which are currently assigned to client devices within a given time period, a current state of network traffic (e.g., frequency of provisioning codes, frequency of requests, and a proximity of client devices requesting codes), or any other suitable factor affecting the probability of providing unique codes to each client device requesting a code. Based on the provision factors, the code module 320 may modify the predetermined set of codes by increasing a number of codes within the predetermined set, adding one or more differentiation indicator to each code of the predetermined set of codes, modifying the one or more differentiation indicators for the predetermined set of codes, or modifying a type of characters used within the predetermined set of codes. For example, to change the number of codes within a range of the predetermined set of codes, the code module 320 may increase a number of characters used within the predetermined set of codes from six characters to seven characters. Differentiation indicators used to enable uniquely provisioning a single code to multiple client devices may include a color (e.g., red, blue, green, and yellow), a location, a range (e.g., a radius extending out from a selected location), or any other suitable differentiating values which may be associated with each code of the predetermined set of codes. The code module 320 may add differentiation indicators in stages, initially using binary differentiation (e.g., two colors for each code) and periodically increase the differentiation indicators based on the one or more provision factors. The code module 320 may modify the predetermined set of codes by changing the predetermined set of codes from characters of a first type (e.g., numbers) to characters of a second type (e.g., alphanumeric characters).

In some embodiments, the first code is associated with a predetermined time period. In providing the first code to the first device, the code module 320 may initialize the predetermined time period based on providing the first code to the first device. In some instances, the code module 320 initializes the predetermined time period by starting the predetermined time period or otherwise identifying a time at which the first code was provided to the first device. Once the predetermined period of time is initialized for the association of the first code and the first device, the code module 320 may identify a time at which the predetermined period of time lapses. Upon expiration or lapsing of the predetermined period of time, the code module 320 dissociates, ends, or otherwise terminates the association of the first code to the first device.

In operation 430, the mapping module 330 maps the first code to the first identifier. The mapping module 330 may generate a map associating the first code and the first identifier. The map generated by the mapping module 330 may be a data structure (e.g., a table or an array) detailing the association of the first code and the first identifier. The map may include associations of a plurality of client devices and a plurality of codes.

In some embodiments, where the codes are associated with predetermined time periods, the mapping module 330 may generate a temporary map or temporary associations within the map. Where the map contains temporary associations, the mapping module 330 may constantly monitor codes having an association within the map. The mapping module 330 may assign associations between the codes and the identifiers within the map. The mapping module 330 may then associate the predetermined time period of each respective code to its position within the map. The mapping module 330 may identify a time at which the predetermined time period expires. Once the predetermined time period for a code expires, the mapping module 330 may remove the code and the associated identifier from the map.

In operation 440, the receiver module 310 receives a second request from a second device (e.g., the second device 114). The second request includes the first code. In some embodiments, the second request includes additional information for processing by the control server system 106. The second request may include a value. The value may represent a monetary value being transferred as part of a transaction represented by the first request and the second request. For example, the first user of the first device may be a purchaser of goods or services and transmit the request to the control server system 106 to begin a transaction between the first user and the second user (e.g., a merchant) of the second device. Once the first code is received by the first device, the first user may provide (e.g., show or send) the code to the second user. The second user may enter the first code and the value into an application to generate the second message and transmit the second message to be received by the receiver module 310.

In operation 450, the identification module 340 selects the first identifier based on inclusion of the first code in the second request. The receiver module 310 may pass all or a portion of the second request to the identification module 340. For example, the receiver module 310 may pass the first code to the identification module 340 and an indication that the first code was received within the second request. In some instances, the identification module 340 may pass the second message to the identification module 340 including the first code and the value. The identification module 340 may identify and select the first identifier based on the map generated by the mapping module 330.

In some embodiments, selecting the first identifier includes one or more sub-operations. The identification module 340 may retrieve the mapping of the first code to the first identifier. After retrieving the mapping, the identification module 340 may retrieve the first identifier from the mapping. The identification module 340 may then pass a provisional confirmation indicator to the confirmation module 350, based on the first code being included in the second request and the first code mapping to the first identifier.

In operation 460, the confirmation module 350 requests a confirmation of the second request from the first device. The request for confirmation may be transmitted from the confirmation module 350 and received and displayed by the first device. The confirmation module 350 may request the confirmation in the form of a third request (e.g., a message) transmitted by the confirmation module 350 to the first device. In some embodiments, the request for confirmation may be transmitted within the application used to generate the first request (e.g., a push notification within the application). In some instances, the request for confirmation may be transmitted outside of the application such as a short message service (SMS) message, a text message, a telephone call, an email, a push notification to the first device, or any other suitable communication between the control server system 106 and the first device.

In operation 470, the provision module 360 processes the second request based on receipt of the confirmation from the first device. In some embodiments, processing the second request includes performing one or more actions within the control server system 106. The control server system 106 may modify one or more values within a database associated with the control server system 106 to process the second request. In some instances, the control server system 106 processes the second request by modifying or transferring a value within the control server system 106 to another domain (e.g., the second domain 104) or another system and modify the map described above to remove the association of the first code and the first identifier.

One or more of the receiver module 310 and the provision module 360 may receive a response (e.g., a confirmation responding to the request for confirmation) to the request for confirmation from the first device. Based on receiving the response from the first device, the provision module 360 processes the second request. In some embodiments, where the second request includes a value (e.g., a monetary value representing payment for an anticipated transaction), the provision module 360 may process the value according to the second request or according to a predetermined process. For example, where the value is or represents a monetary value for a transaction, the provision module 360 may cause transfer of the value from an account associated with the first user or the first device to an account associated with the second user or the second device.

In some embodiments, one or more of a first account (e.g., the account of the first user or first device) and a second account (e.g., the account of the second user or second device) may be associated with a domain other than a domain for the control server system 106. The provision module 360 may generate a provision request to the domain associated with the first account or the second account. The provision request may cause the associated domain to transfer the value to or from the account associated with the domain. For example, where the first account is associated with the first domain 102 of the control server system 106, the provision module 360 may generate the provision request to transfer the value from the first account within the first domain 102 to the second account associated with the second domain 104.

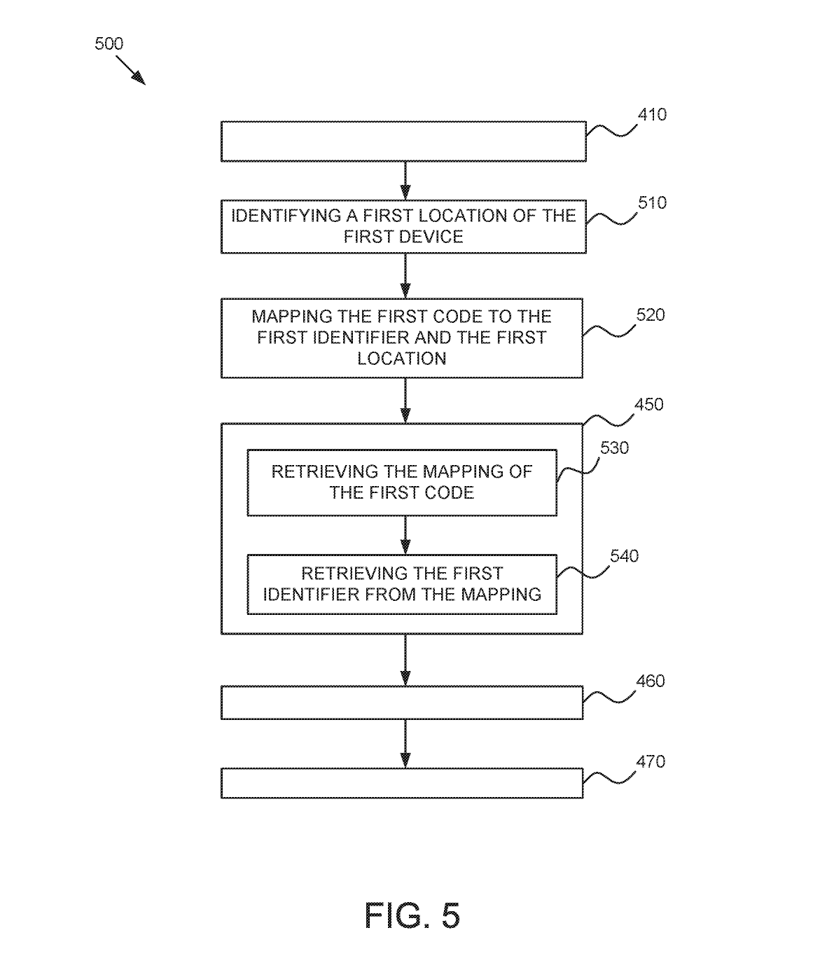

FIG. 5 is a flow diagram of an example method 500 for request authentication based on code and identifier mapping. In example embodiments, operations of the method 500 are performed as one or more sub-operations of one or more operations of the method 400. In example embodiments, the method 500 is initiated by the control server system 106 performing the operations 410.

In operation 510, the identification module 340 identifies a first location of the first device. The first location may indicate a location of the first user, the first device, or a bounded geographical region where the first user or first device is located, or a distance of the user from some known location. In some embodiments, the control server system 106 is configured to generate or select the first code based, at least in part, on a location of the first device. The first location may be included in the first request as received in the operation 410. Where the first location is included in the first request, the first location may be included in the first request based on the first user entering the location into an application on the first device. In some instances, the first location may be included in the first request by the application without user interaction. For example, the application may query the first device for the first location (e.g., global positioning system coordinates, street address, latitude/longitude, or city) of the first device at the time of generating the first request. Where the first location is included in the first request, the identification module 340 may identify the first location by parsing the first request for location data.

In some embodiments, where the first location is not included in the first request, the identification module 340 identifies the first location based on receiving the first request. The identification module 340 may query the first device for the first location. The identification module 340 may query one or more devices of the network 108 responsible for communicating the first request from the first device to the control server system 106. The identification module 340 may also identify the first location based on header data applied to the first request by one or more device of the network 108.

In operation 520, the mapping module 330 maps the first code to the first identifier and the first location. Based on identifying the first location, the identification module 340 passes the first location or data representing the first location to the mapping module 330. The mapping module 330 may map the first code to the first identifier and the first location in a data structure (e.g., a table, a database, or an array). The mapping module 330 may perform the operation 520 in a manner similar to or the same as the operation 430, described above.

In some embodiments, as shown in FIG. 5, the operation 450 includes one or more sub-operation or triggers one or more subsequent operations. In operation 530, the identification module 340 retrieves the mapping of the first code. In some embodiments, in performing the operation 530, the identification module 340 retrieves the mapping based on the first location being within a geo proximity from a second location of the second device from which the second request was received.

Being in geographic proximity could mean that both first device and second device are located within some distance from one another, or within the same bounded geographical region, or within a predetermined distance from some known location.

The identification module 340 may retrieve the mapping based on the first location and the first code. In some instances, the identification module 340 parses the map of associations between codes, locations, and identifiers, to locate the first code. The identification module 340 retrieves data of the association between the first code, the first identifier, and the first location. The identification module 340 identifies the first identifier based on an association of the first code and the first identifier within the map. After identifying the first identifier, the identification module 340 may identify the first location within the association and compare the first location with the second location. Where the first location is within a geographical proximity within a predetermined threshold, the identification module 340 may confirm retrieval and identification of the first identifier.

In operation 540, the identification module 340 retrieves the first identifier from the mapping. The identification module 340 may retrieve the first identifier based on confirming the identification of the first identifier based on the comparison of the first location and the second location and the first and second locations being within the predetermined threshold of geographical proximity.

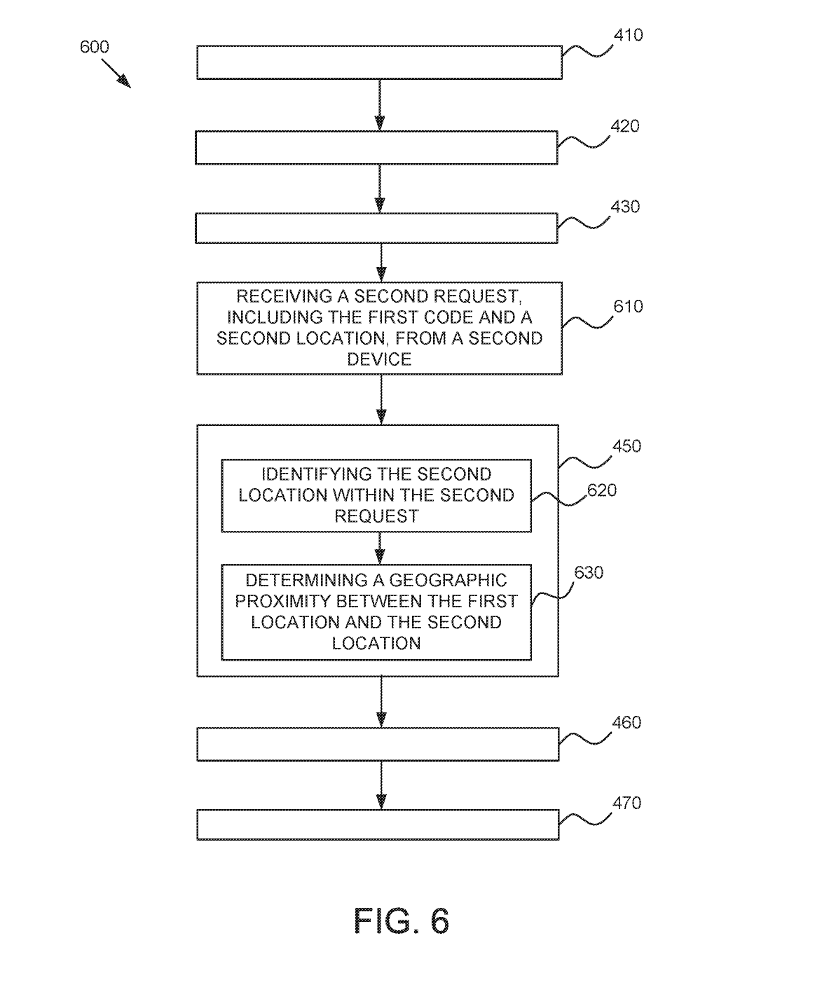

FIG. 6 is a flow diagram of an example method 600 for request authentication based on identifier and code mapping. In example embodiments, operations of the method 600 are performed as one or more sub-operations of one or more operations of the method 400. In example embodiments, the method 600 is initiated by the control server system 106 performing the operations 410-430.

In operation 610, the receiver module 310 receives a second request from a second device. The second request includes the first code and a second location. In some embodiments, the operation 610 may be performed similarly to or the same as the operation 440. The receiver module 310 may pass all or a portion of the second request to the identification module 340. For example, the receiver module 310 may pass the second location or data representing the second location to the identification module 340.

In some embodiments, as shown in FIG. 6, the operation 450 includes one or more sub-operations or triggers one or more subsequent operations. In operation 620, the identification module 340 identifies the second location within the second request. In these instances, the identification module 340 receives the second request from the receiver module 310. In some embodiments, the identification module 340 parses the second request to identify the second location contained within the second request. The identification module 340 may identify the second location within the second request by locating a predetermined portion of the second request configured to contain the second location. The identification module 340 may also identify the second location from a header or other portion of a packet frame.

In operation 630, the identification module 340 determines the geographic proximity between the first location and the second location. The geographic proximity may be a distance, a radius, a zip code (e.g., a postal code), a region, an intersection of radii centered about the first location and the second location. The identification module 340 may determine the geographic proximity between the first location and the second location in comparison to a predetermined proximity threshold. For example, the identification module 340 may identify whether the geographic proximity exceeds the predetermined proximity threshold. Where the geographic proximity exceeds the predetermined proximity threshold, the identification module 340 may pass a failure indication to one or more modules of the control server system 106 indicating the second request failed to authenticate against the first request based on the geographic proximity. Where the geographic proximity is less than the predetermined proximity threshold, the identification module 340 may pass an authentication indication to the provision module 360 to process the second request, as described above with respect to the operation 460.

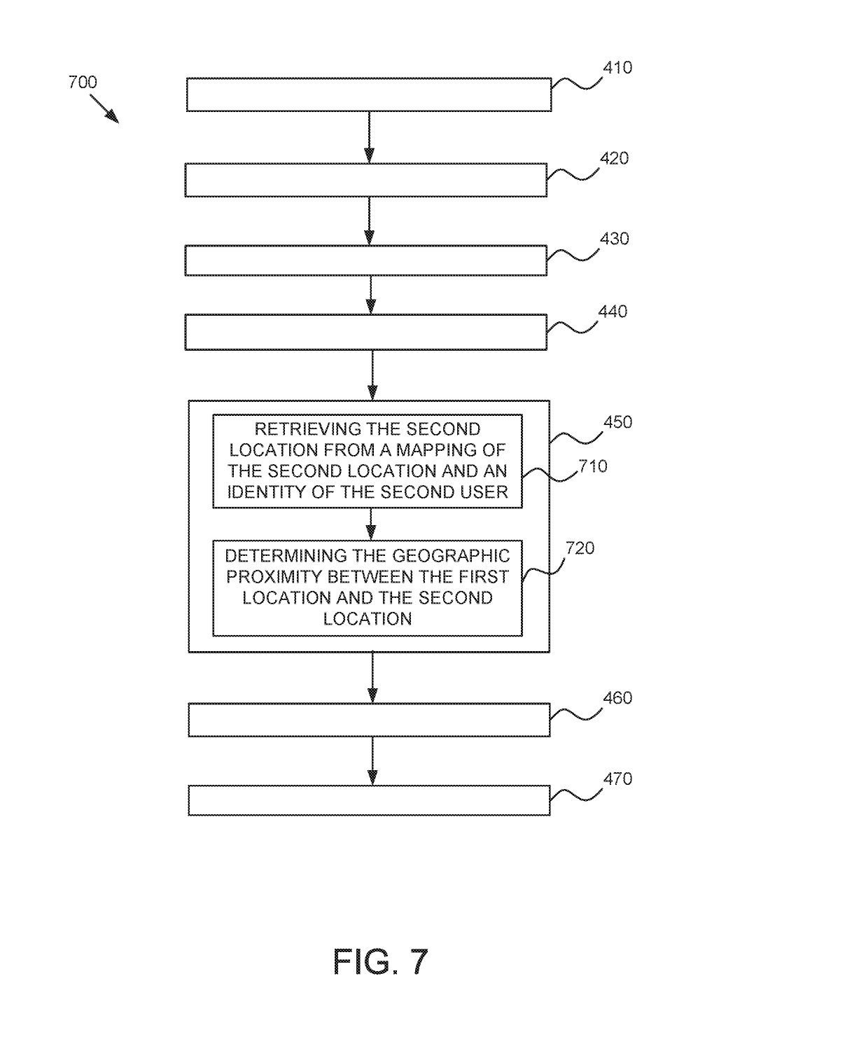

FIG. 7 is a flow diagram of an example method 700 for request authentication based on identifier and code mapping. In example embodiments, operations of the method 700 are performed as one or more sub-operations of one or more operations of the method 400. In example embodiments, the method 600 is initiated by the control server system 106 performing the operations 410-430.

In some embodiments, a second location may be associated with one or more of the second user and the second device. The second location may be received by the receiver module 310 at a point prior to receiving the second request. The second location may be received in a registration process associating one or more of the second user and the second device with the second location. For example, where the second user is a merchant with a storefront location, the second location may be the location of the storefront and be provided when the second user registers with the control server system 106. The mapping module 330 of the control server system 106 may generate associations between users of the control server system 106 and locations, where the user provides a stationary location during the registration process. The mapping module 330, receiving the locations, may generate a map (e.g., a data structure) associating users with specified locations.

In operation 710, the identification module 340 retrieves the second location from a mapping of the second location and an identity of the second user associated with the second device. In these embodiments, the second location is a stationary location specified by the second user and associated with one or more of the second user and the second device. The identification module 340 may retrieve the second location based on receiving the second request from the second device. The identification module 340 may identify the second device, to retrieve the second location and the identity of the second user, based on a content of the second request. For example, the second request may include a machine identifier uniquely identifying the second device.

In operation 720, the identification module 340 determines the geographic proximity between the first location and the second location. The identification module 340 may compare the geographic proximity with a predetermined proximity threshold to identify whether to authenticate and process the second request. In some embodiments, the operation 720 may be performed similarly to or the same as the operation 630.

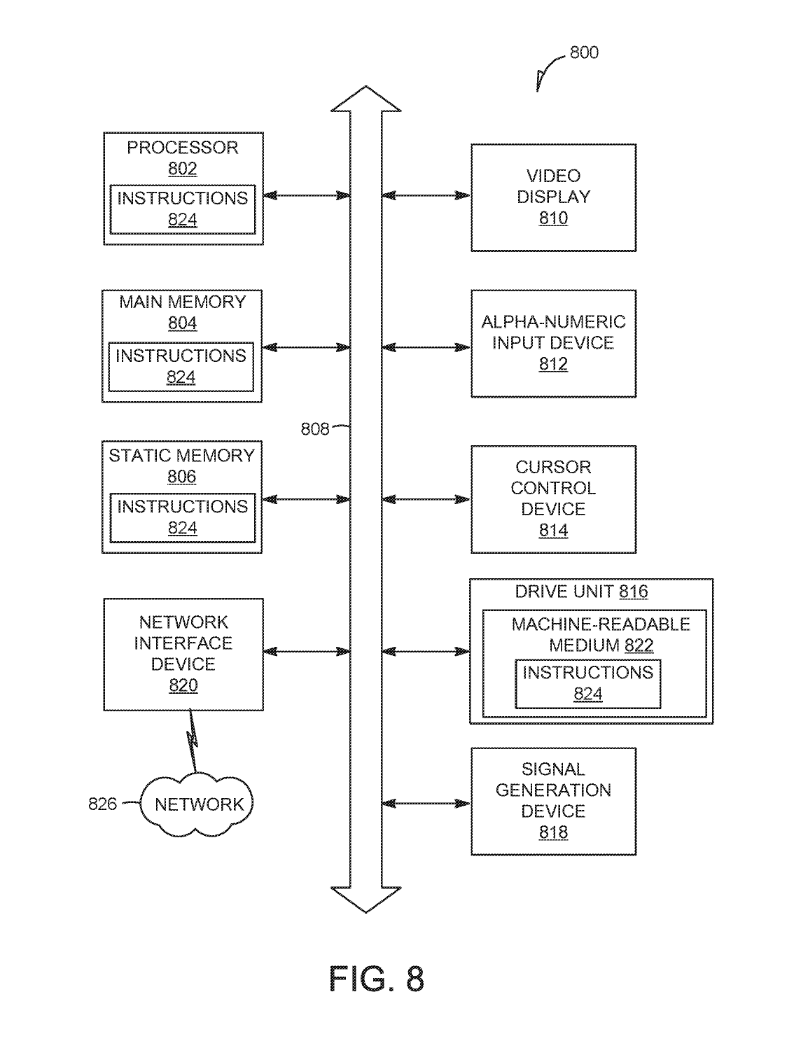

FIG. 8 is a block diagram illustrating components of a machine 800, according to example embodiments, able to read instructions (e.g., processor executable instructions) from a machine-readable medium (e.g., a non-transitory processor-readable storage medium) and perform any one or more of the methodologies discussed herein. Specifically, FIG. 8 shows a diagrammatic representation of the machine 800 in the example form of a computer system and within which instructions 824 (e.g., software, a program, an application, an applet, an app, or other executable code) for causing the machine 800 to perform any one or more of the methodologies discussed herein may be executed. In alternative example embodiments, the machine 800 operates as a standalone device or may be connected (e.g., networked) to other machines. In a networked deployment, the machine 800 may operate in the capacity of a server machine or a client machine in a server-client network environment, or as a peer machine in a peer-to-peer (or distributed) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics/video display 810 (e.g., a plasma display panel (PDP), a light emitting diode (LED) display, a liquid crystal display (LCD), a projector, or a cathode ray tube (CRT)). The machine 800 may also include an alpha-numeric input device 812 (e.g., a keyboard), a cursor control device 814 (e.g., a mouse, a touchpad, a trackball, a joystick, a motion sensor, or other pointing instrument), a storage/drive unit 816, a signal generation device 818 (e.g., a speaker), and a network interface device 820.

The storage unit 816 includes a machine-readable medium 822 on which is stored the instructions 824 embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered as machine-readable media. The instructions 824 may be transmitted or received over a network 826 via the network interface device 820.

As used herein, the term “memory” refers to a tangible machine-readable medium able to store data temporarily or permanently and may be taken to include, but not be limited to, random-access memory (RAM), read-only memory (ROM), buffer memory, flash memory, and cache memory. While the tangible machine-readable medium 822 is shown in an example embodiment to be a single medium, the terms “machine-readable medium” and “processor-readable medium” should be taken to include a single medium or multiple media (e.g., a centralized or distributed database, or associated caches and servers) able to store instructions. The terms “machine-readable medium” and “processor-readable medium” shall also be taken to include any medium, or combination of multiple media, that is capable of storing instructions for execution by a machine (e.g., machine 800), such that the instructions (e.g., instructions 824), when executed by one or more processors of the machine (e.g., processor 802), cause the machine to perform any one or more of the methodologies described herein. Accordingly, a “machine-readable medium” or “processor-readable medium” refers to a single storage apparatus or device, as well as “cloud-based” storage systems or storage networks that include multiple storage apparatus or devices. The terms “machine-readable medium” and “processor-readable medium” shall accordingly be taken to include, but not be limited to, one or more data repositories in the form of a solid-state memory, an optical medium, a magnetic medium, or any suitable combination thereof.

Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 824 may further be transmitted or received over a communications network 826 using a transmission medium via the network interface device 820 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain example embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some example embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering example embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In example embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader scope of embodiments of the present invention. Such example embodiments of the inventive subject matter may be referred to herein, individually or collectively, by the term “invention” merely for convenience and without intending to voluntarily limit the scope of this application to any single invention or inventive concept if more than one is, in fact, disclosed.

The example embodiments illustrated herein are described in sufficient detail to enable those skilled in the art to practice the teachings disclosed. Other example embodiments may be used and derived therefrom, such that structural and logical substitutions and changes may be made without departing from the scope of this disclosure. The Detailed Description, therefore, is not to be taken in a limiting sense, and the scope of various example embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various example embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of example embodiments of the present invention as represented by the appended claims. The specification and drawings are, accordingly, to be regarded in an illustrative rather than a restrictive sense.

What is claimed is:

1. A method, comprising:
receiving, at a control server, a first request from a first device, the first request including a first identifier of a first user and a request for a code;
in response to the first request, providing a first code to the first device;
mapping, by the control server, the first code to the first identifier;
receiving, at the control server, a second request from a second device, the second request including the first code;
selecting, at the control server, the first identifier based on inclusion of the first code in the second request;
requesting, by the control server, a confirmation of the second request from the first device; and
processing the second request based on receipt of the confirmation from the first device.

2. The method of claim 1, wherein the first code is associated with a predetermined period of time and the second request is received within the predetermined period of time from the providing of the first code.

3. The method of claim 1, wherein selecting the first identifier further comprises:
retrieving the mapping of the first code to the first identifier; and
retrieving the first identifier from the mapping.

4. The method of claim 1, wherein the first request includes a first value and providing the first code further comprises generating the first code based on the first value.

5. The method of claim 1, wherein the control server identifies a first location of the first device and the mapping further comprises:
mapping, by the control server, the first code to the first identifier and the first location.

6. The method of claim 5, wherein selecting the first identifier based on the inclusion of the first code in the second request further comprises:
retrieving the mapping of the first code, based on the first location being within a geographic proximity from a second location of the second device; and
retrieving the first identifier from the mapping.

7. The method of claim 6, wherein the second location is included in the second request and selecting the first identifier based on the inclusion of the first code in the second request further comprises:
identifying the second location within the second request; and
determining the geographic proximity between the first location and the second location.

8. The method of claim 6, wherein the second location is associated with the second device and selecting the first identifier based on the inclusion of the first code in the second request further comprises:
in response to receiving the second request, retrieving the second location from a mapping of the second location and an identity of the second device; and determining the geographic proximity between the first location and the second location.

9. A system, comprising:
one or more processors; and
a non-transitory processor-readable storage medium storing processor executable instructions that, when executed by the one or more processors, cause the one or more processors to perform operations including:
receiving, at a control server, a first request from a first device, the first request including a first identifier of a first user and a request for a code;
in response to the first request, providing a first code to the first device;
mapping, by the control server, the first code to the first identifier;
receiving, at the control server, a second request from a second device, the second request including the first code;
selecting, at the control server, the first identifier based on inclusion of the first code in the second request;
requesting, by the control server, a confirmation of the second request from the first device; and
processing the second request based on receipt of the confirmation from the first device.

10. The system of claim 9, wherein the first code is associated with a predetermined period of time and the second request is received within the predetermined period of time from the providing of the first code.

11. The system of claim 9, wherein the selecting the first identifier further comprises:
retrieving the mapping of the first code to the first identifier; and
retrieving the first identifier from the mapping.

12. The system of claim 9, wherein the first request includes a first value and providing the first code further comprises generating the first code based on the first value.

13. The system of claim 9, wherein the control identifies a first location of the first device and the mapping further comprises:
mapping, by the control server, the first code to the first identifier and the first location.

14. The system of claim 13, wherein selecting the first identifier based on the inclusion of the first code in the second request further comprises:
retrieving the mapping of the first code, based on the first location being within a geographic proximity from a second location of the second device; and
retrieving the first identifier from the mapping.

15. The system of claim 14, wherein the second location is included in the second request and selecting the first identifier based on the inclusion of the first code in the second request further comprises:
identifying the second location within the second request; and
determining the geographic proximity between the first location and the second location.

16. The system of claim 14, wherein the second location is associated with the second device and selecting the first identifier based on the inclusion of the first code in the second request further comprises:
in response to receiving the second request, retrieving the second location from a mapping of the second location and an identity of the second device; and
determining the geographic proximity between the first location and the second location.

17. A non-transitory processor-readable storage medium storing processor executable instructions that, when executed by a processor, cause the processor to perform operations comprising:
receiving, at a control server, a first request from a first device, the first request including a first identifier of a first user and a request for a code;
in response to the first request, providing a first code to the first device;
mapping, by the control server, the first code to the first identifier;
receiving, at the control server, a second request from a second device, the second request including the first code;
selecting, at the control server, the first identifier based on inclusion of the first code in the second request;
requesting, by the control server, a confirmation of the second request from the first device; and
processing the second request based on receipt of the confirmation from the first device.

18. The non-transitory processor-readable storage medium of claim 17, wherein the control server identifies a first location of the first device and the operations further comprise:
mapping, by the control server, the first code to the first identifier and the first location;
retrieving the mapping of the first code based on the first location being within a geographic proximity from a second location of the second device; and
retrieving the first identifier from the mapping.

19. The non-transitory processor-readable storage medium of claim 18, wherein the second location is included in the second request and selecting the first identifier based on the inclusion of the first code in the second request further comprises:
identifying the second location within the second request; and
determining the geographic proximity between the first location and the second location.

20. The non-transitory processor-readable storage medium of claim 18, wherein the second location is associated with the second device and selecting the first identifier based on the inclusion of the first code in the second request further comprises:
in response to receiving the second request, retrieving the second location from a mapping of the second location and an identity of the second device; and
determining the geographic proximity between the first location and the second location.
